(19) United States
(12) Patent Application Publication
(10) Pub. No.: US 2001/0005168 A1
(43) Pub. Date: Jun. 28, 2001

(54) Installation for the remote monitoring of a park of heterogeneous industrial production apparatuses

(76) Inventors: Laurent Ferenczi, Paris (FR); Frederic Barth, Paris (FR)

Correspondence Address: YOUNG & THOMPSON, 745 SOUTH 23RD STREET 2ND FLOOR, ARLINGTON, VA, 22202

(21) Appl. No.: 09/768,593

(22) Filed: Jan. 25, 2001

Related U.S. Application Data
(63) Continuation of application No. 09/105,196, filed on Jun. 26, 1998.

(30) Foreign Application Priority Data
Jun. 26, 1997 (FR) 97 08028

(51) Int. Cl. H04M 11/00; G05B 23/02

(52) U.S. Cl. 340/3.1; 379/100.05

(57) ABSTRACT

The installation for the remote monitoring of a park of heterogeneous industrial production apparatuses (18, 22, 26) comprises, for each apparatus (18, 22, 26), means (20A, 20B, 24A, 24B, 32A, 32B) for reading informations relating to the operation of the apparatus. These informations reading means are connected to means (48, 50, 52, 54) for the remote monitoring of the apparatus by communication means 40 associated with the apparatus (18, 22, 26) and adapted for the communication of the data from the apparatus to the remote monitoring means. All the communication means (40) comprise analog means for the structuration of the data in accordance with a unified structure independent of the type of the apparatus and of the read informations. The remote monitoring means comprise at least one monitoring station (48, 50, 52, 54) to the communication means (40) of all of the apparatuses. The or each station comprises means for exploiting the unified structure informations read from one or more apparatuses.

The present invention relates to an installation for the remote monitoring of a park of heterogeneous industrial production apparatuses, of the type comprising, for each apparatus, means for reading informations relating to the operation of the apparatus, which information reading means are connected to means for the remote monitoring of the apparatus by communication means associated with said apparatus and adapted for the communication of said informations from said apparatus to said remote monitoring means.

Installations are for example known for the storage of gas comprising tanks provided with level sensors. These level sensors are connected by communication lines to devices displaying the levels. The display means are disposed at a distance, in particular on the premises of the service in charge of the replenishing of the tanks.

Further, in the case of other applications, for example the detection of fire in an industrial unit, other means for reading informations, in particular temperature sensors, are connected by different communication means to remote monitoring centres which are also provided with means suitable for the application to the detection of fire.

All the known remote monitoring installations employ communication means specifically adapted to the considered application and permitting the transmission to tho monitoring centre of solely informations required in the given context.

Also, for each type of industrial production apparatus which must be monitored and for each monitoring application, the installation must be entirely designed for taking into account requirements relating in particular to the type, the quantity, and the speed of transmission of the informations which must be sent to the remote monitoring means. Consequently, different communication means and different monitoring means must be developed for each type of apparatus. This involves high costs for installing such installations.

An object of the invention is to provide a solution to the aforementioned problems and in particular to provide a monitoring installation capable of ensuring the monitoring of a park of industrial production apparatuses employing apparatuses of different types, without the elements constituting the installation having been entirely designed for each type of apparatus and for each follow up and monitoring.

The invention therefore provides an installation for the remote monitoring of a park of heterogeneous industrial apparatuses, of the aforementioned type, characterized in that all the communication means associated with said apparatuses comprise analog means for the structuration of the informations lead from the apparatus, in accordance with a unified structure, independent of the type of the apparatus and of the read informations, and the remote monitoring means comprise at least one monitoring station connected to the communication means of all of the apparatuses, the or each monitoring station comprising means for exploiting the unified structure informations read from one or more apparatuses.

According to other particular embodiments, the installation may have one or more of the following features:

it comprises a plurality of monitoring stations connected to the communication means of all of the apparatuses;

all the means for exploiting the informations of the or each monitoring station comprise analog moans for processing the informations of unified structure, the processing being independent of the type of the apparatus and of the read informations and means for interpreting said processed informations, which interpreting means are specific to the considered type) of apparatus;

the or each monitoring station comprises means for establishing data for commanding an apparatus and analog means for the structuration of the apparatus command data according to a unified structure, independent of the type of the apparatus to be commanded and of the command data, and means for transmitting said thus structured command data from said monitoring station to the communication means associated with said apparatus and said communication means associated with said apparatus comprise means for driving the apparatus in accordance with the received command data;

the information reading means are adapted to read a reduced number of elementary informations;

the communication means associated with each apparatus comprise a microcomputer provided with a program adapted for the structuration of the informations read from said apparatus in accordance with said unified structure from informations read from said apparatus, said microcomputer comprises an interface for coupling to a network to which are connected the communication means of the other apparatuses and the or each monitoring station, and

said network is a telephone network.

A better understanding of the invention will be had from the following description which is given solely be way of example with reference to the accompanying drawings in which:

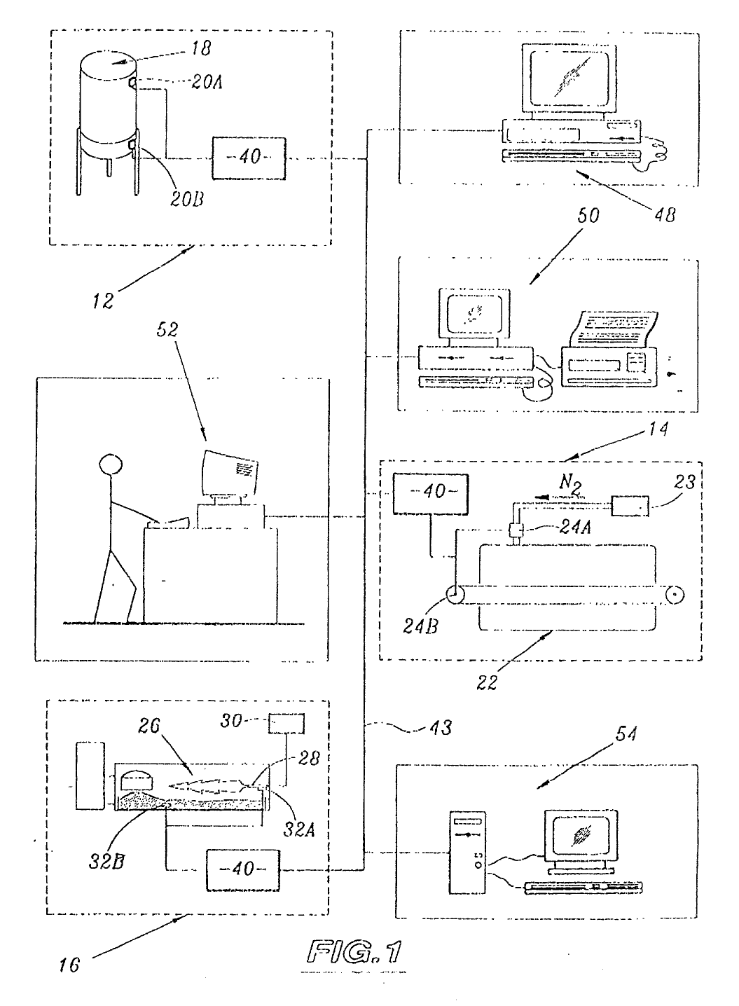

FIG. 1 is a diagrammatic view of an installation according to the invention;

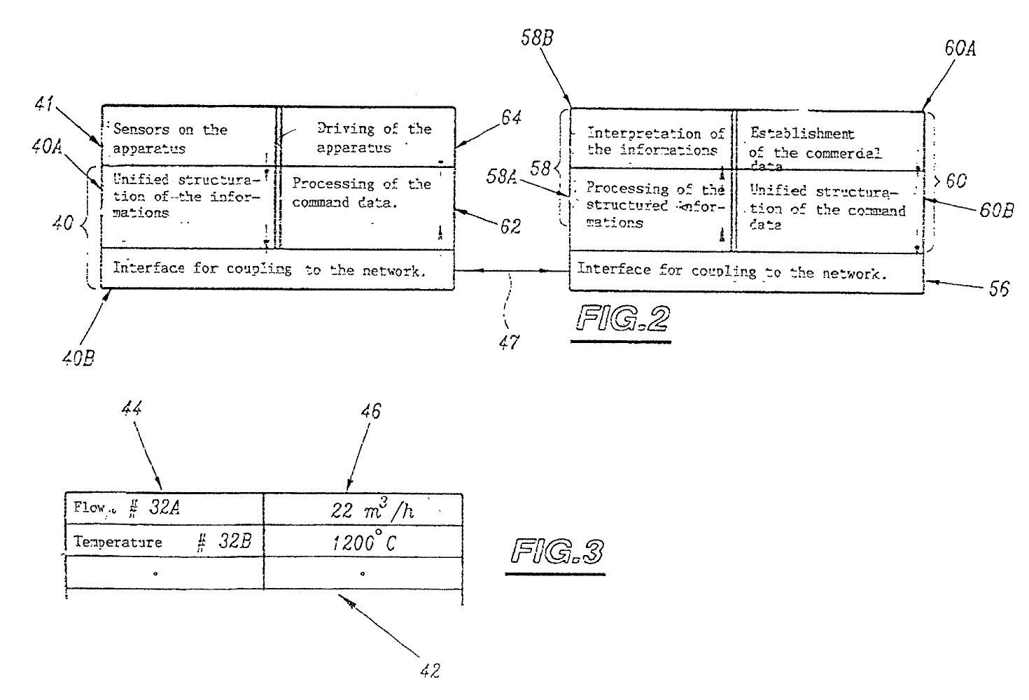

FIG. 2 is a diagrammatic view of the general structure of the monitoring installation, and

FIG. 3 is a diagrammatic view of an example of a table showing the structuration of the data.

The monitoring installation shown in FIG. 1 is adapted for the monitoring of three industrial sites designated 12, 14, 16. These industrial sites are assumed to be spaced from one another, i.e. arranged on the territory of a state or continent.

All these industrial sites employ industrial production apparatuses of different types. Thus, the monitoring installation i s applied to a park of heterogeneous apparatuses.

The industrial site 32 exploits a storage tank 18 containing for example liquid nitrogen. This tank feeds a nitrogen-consuming installation (not shown). it comprises a first high-level sensor 20A and a second low level sensor 20B which are adapted to detect the maximum and minimum levels in the tank.

The first and second sensors are formed by pressure sensors effecting measurements at the top and at the bottom of the tank. They are connected to calculating means for determining the level from the two measured pressures.

The industrial site 14 exploits a refrigerating tunnel 22 for the freezing or deep freezing of food products. This tunnel comprises an enclosure through which extends a conveyor belt on which the products to be treated travel. The enclosure of the tunnel is fed with a refrigerating liquid for example liquid nitrogen from a storage tank 23.

A first sensor, 24A, for example a flow meter, is disposed in the liquid nitrogen supply pipe for measuring the quantity of refrigerating liquid used in the tunnel and checking the correct circulation of this liquid. A second sensor 24B is provided on the conveyor belt for determining in particular its travelling speed.

The industrial site 16 comprises a glass furnace 26 having a burner 28 fed with fuel gas from a storage tank 30.

A first sensor 32A is mounted on the burner 28 to determine the state of operation of the latter and the flow of the fuel consumed. A second sensor 32B is disposed in the enclosure of the furnace to determine the temperature inside t he latter.

The means for reading informations formed by the sensors associated with the different apparatuses are adapted to read a reduced number of elementary informations relating to the operation of the apparatuses. This number of informations for example is less than 100 and in particular less than 10.

According to the invention, each of the information reading means is connected on each site to communication means carrying the reference numeral 40.

The structure of the communication means 40 is illustrated in FIG. 2 in which the sensors based on the same apparatus carry the same general reference numeral 43.

These communication means 40 all include analog means 40A for the structuration of the informations read from the associated apparatus in accordance with a unified structure.

Temporary memory means for storing the thus structured informations are provided in the communication means 40. They ensure the storage of said informations up to their transmission to the monitoring means which will be described hereinafter,

The unified structure in accordance with which the informations are organized is independent of the type of apparatus and the informations received.

For each apparatus, the structure of the informations comprises for example a table diagrammatically shown in FIG. 3 and designated by the reference numeral 42.

In a first column 44 of this table there is indicated the name of the considered sensor and in a second column 46 there is indicated the value or the characteristic read by this sensor at a given instant.

Table 42 given as an example in FIG. 3 corresponds to the table produced by the communication means 40 of the industrial site 16.

On the first line, the sensor 32A, shown in column 44, is designated by the expression “flow # 32A”. The value measured by this sensor at the considered instant and shown on the same line in column 46 is equal to 22 m³/h.

Likewise, the second sensor is designated by the expression “temperature #32B”. At the considered instant, the read temperature value is equal to 1200°C.

In a similar way, the communication means 40 of the site 12 ensure the structuration of the informations in accordance with a table comprising names for the two level sensors 20A and 20B and the states of the these sensors.

Likewise, the table produced by the communication means 40 of the site 14 comprise variable names for the flow read by the sensor 24A and the speed of the conveyor belt measured by the sensor 24B. It further comprises the values measured by these two sensors.

The communication means 40 associated with each apparatus comprise for example a microcomputer of the PC type provided with an interface for connection to the sensors provided on the apparatus. The same program adapted for the structuration of the informations read from the apparatus is fed into each microcomputer.

This program which insures the structuration of the informations in accordance with said unified structure is in particular adapted to introduce in one or more tables the values received from the different sensors.

The tables are previously defined by an operator during the configuration of the program. This configuration step essentially consists in defining the names of the sensors which must be shown in the tables and in associating the thus defined variables with the sensors physically installed on the considered apparatus.

Further, during the configuration, the program receives informations identifying the site and the apparatus. The identification informations are thereafter reproduced in the table associated with the apparatus for their recognition.

Whatever apparatus is associated with the communication means 40, the informations read from the apparatus are thus structured by the program in accordance with a unified structure the form of which is independent of the type and quantity of the read informations.

These thus structured informations are temporarily stored in the memory of the microcomputer of the communication means associated with each apparatus.

Further, the microcomputer employed in the communication means comprises an interface 40B (FIG. 2) for coupling to the telephone network , the latter being designated by the reference numeral 47 in the Figures.

The installation according to the invention further comprises means for the remote monitoring of the park of apparatuses installed on the different sites.

The monitoring means comprise monitoring stations disposed on the distinct sites of the territory. In FIG. 1, four monitoring stations associated with distinct sites have been shown and are designated by the reference numerals 48, 50, 52, and 54.

Each monitoring station comprises a microcomputer connected to the telephone network 47 by a coupling interface. The structure of a monitoring station is diagrammatically shown in FIG. 2 where the interface for coupling to the network is designated by the reference numeral 56.

The stations 48 to 54 comprise means 58 for exploiting the informations of unified structure read from one or more of the apparatuses connected to the installation. These informations exploiting moans are formed essentially by a program entered in the microcomputer constituting the monitoring station.

As diagrammatically shown in FIG. 2, the means 58 for exploiting the informations comprise for all the monitoring stations analog means 58A for processing the informations of unified structure. These means 58A comprise means for reading and analyzing the tables 42. The processing effected by the means 58A is independent of the type of apparatus from which the informations were read and of the type of the read information. It consists essentially in the identification of the table or different tables in particular as concerns the origin and in a storage of said tables in the memory of the microcomputer employed for forming the monitoring station. This storage, which is effected in a form independent of the type of informations, is adapted to permit a use of the informations by other programs of the supervising station.

Further, the means 58 for exploiting the informations comprise means 58B for interpreting the informations from the processing means 58A.

As opposed to the means 58A for processing the unified structure informations, the interpretation means 58B are specific to the type of apparatus from which the informations come and to the application of the considered monitoring.

These means 58B are formed by one or more programs loaded in each monitoring station. These programs are for example adapted for a presentation of informations enabling them to be understood by an operator. These means may comprise automatic means for initiating an alarm procedure in accordance with the received informations, for example the initiation of a sound or light signal, the automatic calling of an operator on a portable telephone or the sending of a fax.

A given monitoring station comprises a plurality of interpretation programs to be able to exploit the informations issuing front apparatuses of different types. Thus, the same monitoring station may permit access to the informations read from any one of the apparatuses connected to the installation.

The monitoring stations may be assigned to different entities. By way of illustration, the stations 48 to 54 will now be described together with their informations exploiting means.

In the installation shown in FIG. 1, the station 48 is assumed to be associated with a liquid gas distribution centre. Thus, the monitoring station ensures, by means of the installation according to the invention, the monitoring of the levels in the tanks connected to the installation by calculation from the pressures detected by the sensors 20A and 20B. in the case of the industrial site 12 for example, the sensors 20A and 20B permit effecting a reading of level informations on the tank 18. These informations are read at regular intervals of time. They are put into a form in accordance with the unified structure by the moans 40A for the structuration of informations and stored in the memory of the communication means 40 associated with the tank 18.

Upon request from the monitoring station 48, the temporarily stored structured informations are transmitted from the communication means 40 to the monitoring station 48. The latter then exploits the informations received. For this purpose, the informations processing means 58A store the informations in the memory of the monitoring station in a form which is exploitable by the interpretation means 58B. The latter for example display the informations on a screen to render them accessible to an operator.

When the level in the tank is lower than a predetermined level, the operator decides, in consulting the informations available at the station 48, to send a truck for replenishing the tank.

Although this is not shown, the tanks 23 and 30 are also provided with level sensors connected to the communication means 40 of the corresponding site.

Further, the communication means 40 are adapted to initiate, on their own initiative, the sending of an alarm to the monitoring station 48. The monitoring station 48 broadcasts the informations in accordance with predetermined criteria of gravity through suitable interfaces, such as a fax, telephone, moving text receiver or a printer.

The monitoring station 50 is intended for the invoicing of the services provided by the different apparatuses of the park installed on remote sites.

In a manner similar to that of the monitoring station 48, the monitoring station 50 permits an interrogation of the communication means 40 of the different sites for receiving the tables comprising the informations read by the sensors. These informations which may be of any type are then processed by the interpretation moans 58B suitable for an accountancy application. These interpretation means provide a different interpretation of the informations in accordance with the type of apparatus from which they come.

It will be understood that owing in particular to the flow of fluid employed by an apparatus, or the travelling speed of the conveyor in the latter, it is possible to carry out accountancy operations for invoicing the service provided by the apparatus.

Thus the use of a unified informations structure for all the apparatuses whatever their type and the type of informations read, enables the single monitoring station 50 to effect the invoicing and the analysis of the production of the services afforded by heterogeneous apparatuses.

The station 52 is installed at the head office of the company managing the different apparatuses of the park. It permits consulting all the informations received from the whole of the park of apparatuses.

This is made possible by the use of information structuration means on each of t-he sites in accordance with the same unified structure in the different communication means 40.

Indeed, whatever the informations received from the apparatuses, the structure of the informations being analog, these informations may be read from any monitoring station, the latter comprising all the analog means 58A for processing the thus structured informations.

The station 54 is disposed in a unit for the maintenance of the different apparatuses. The exploitation means 58 of this station comprise means for consulting informations relating to the operation of the different apparatuses so as to detect possible breakdowns or faults.

Further, all of the monitoring stations or only some of them comprise means 60 for the remote command or driving of the apparatuses connected to the monitoring installation.

The command means 60 are brought into action essentially by a program loaded in the microcomputer forming the monitoring station. These command means, diagrammatically shown in FIG. 2, comprise means 60A for establishing command data for a plurality of apparatuses connected to the installation.

These means 60A permit in particular the definition of instructions for the command of these apparatuses. These instructions may be acquired directly on a keyboard by the operator or be automatically calculated from a regulation algorithm in accordance with informations read from a corresponding apparatus.

As a variant, the instructions represent a command to stop an apparatus or to restart the latter, in particular after an accidental stoppage.

All the command means 60 further comprise analog means 60B for the structuration of the command data thus established in accordance with a unified structure. This unified structure in independent of the type of apparatus to be controlled and of the command data.

For example, tho means 60B for the structuration of the command data are adapted to produce tables in a form substantially similar to that shown in FIG. 3, the first column of the tables showing the name of an operational parameter of the apparatus which may be commanded and the second column showing the set value forming the command data associated with this parameter.

The coupling interface to the network 56 comprises means for the transmission of the thus structured command data to the apparatus to be controlled.

Further, each apparatus which may be commanded is associated with means 62 for processing the command data. These means are similar for all the apparatuses and are integrated in the form of a program in the communication means 40.

In particular, these means 62 for processing the command data are adapted to take the command instructions from the command data structured in a unified manner and to send them to the driving means 64 of the apparatus.

Those driving means 64 are specific to the considered type of apparatus and are formed for example by a programmable automation which drives the apparatus in accordance with the command data.

It will be understood that with such an installation it is possible from any monitoring station provided with command means, to define the command data and send the latter to an apparatus of the installation for modifying its operation.

Indeed, whatever type of apparatus used and whatever the type of command data which must be sent, the structuration means 60B ensure a structuration of the data in accordance with a unified structure, which structure may be interpreted by the processing means 62 of the receiving apparatus.

These data are finally carried out by the driving means 64 specific to the commanded apparatus.

In the presently-described embodiment, each of the monitoring stations has access to the communication means of all the apparatuses of the installation, However, this access may be limited by the use of access codes or by reducing the possibilities of connection of the monitoring stations by the elimination of certain functions of the program they employ.

It will be understood that the cost of installing such a monitoring installation is limited, although the processing power of each of the monitoring stations and the communication means 40 must be overdimensioned relative to the reduced number of processed informations from the reading means. Indeed, the use of the same structuration of the informations and of the command data for all the apparatuses and for all the monitoring stations permits using in the installation standard elements which require only a simple configuration without need for all the elements to be completely redefined in accordance with the apparatus and the monitoring application.

Further, the installation permits the use of the same monitoring station for several monitoring applications effected in particular, on apparatuses of different types.

Likewise, the same communication means 40 associated with an apparatus may be used for several monitoring applications and in particular from several monitoring stations.

What is claimed is:

1. Installation for the remote monitoring of a park of heterogeneous industrial production apparatuses comprising, for each apparatus, means for reading informations relating to the operation of said apparatus, means for the remote monitoring of said apparatus, communication means associated with said apparatus and connecting said apparatus to said monitoring means and adapted for the communication of said informations from said apparatus to said remote monitoring means, all of said communication means associated with said apparatuses comprising in combination: analog means for the structuration of said informations read from said apparatus, in accordance with a unified structure, independent of the type of apparatus and of said read informations, and said remote monitoring means comprising at least one monitoring station connected to said communication means of all of said apparatuses, said at feast one monitoring station comprising means for exploiting said unified structure informations read from one or more apparatuses.

2. Installation according to claim 1, comprising a plurality of said at least one monitoring station connected to the communication moans of all of said apparatuses.

3. Installation according to claim 1, wherein all said means for exploiting informations from said at least one monitoring station comprise analog means for processing said informations of unified structure, said processing being independent of the type of apparatus and of the read informations, and means for interpreting said processed informations, said interpreting means being specific to the considered type of apparatus.

4. Installation according to claim 1, wherein each of said at least one monitoring station comprises means for establishing data for commanding an apparatus, and analog means for the structuration of said apparatus commanding data in accordance with a unified structure independent of the typo of the apparatus to be commanded and of said apparatus commanding data, and means for transmitting said thus structured apparatus commanding data from said at least one monitoring station to said communication means associated with said apparatus and said communication means associated with said apparatus comprise means for driving said apparatus in accordance with the received commanding data.

5. Installation according to claim 1, wherein said means for reading informations are adapted to read a reduced number of elementary in formations.

6. Installation according to claim 1, wherein said communication means associated with each apparatus comprise a microcomputer provided with a program adapted for the structuration of said informations read from said apparatus in accordance with said unified structure from informations read from said apparatus, said microcomputer comprising an interface for coupling to a network to which the communication means of the other apparatuses and said at least one monitoring station are connected.

7. Installation according to claim 6, wherein said network is a telephone network.

8. Method for the remote monitoring of a park of heterogeneous industrial production apparatuses from means for the remote monitoring of the type comprising the steps of, for each apparatus, reading informations relating to the operation of the apparatus, and communicating said informations from said apparatus to said remote monitoring means, characterized in that for the communication between all said apparatus to said remote monitoring means, the informations read from the apparatus are structurated, in accordance with a unified structure, independent of the type of the apparatus and of the read informations, and the unified structure informations read from one or more apparatuses are exploited by said remote monitoring means.

9. Method according to claim 8, wherein for exploiting the informations, the processing of the informations of unified structure is independent of the type of apparatus and of the read informations, and said processed informations are interpreted by interpreting means which are specific to the considered type of apparatus

10. Method according to claim 8 or 9, wherein the monitoring means establish data for commanding an apparatus, the command data being structured according to a unified structure independent of the type of the apparatus to be commanded and of the command data, and wherein structured control data are transmitted from said monitoring means to the apparatus to be commanded which is piloted in accordance with the received command data.
